(19) United States
(12) Patent Application Publication
(10) Pub. No.: US 2025/0021278 A1
(43) Pub. Date: Jan. 16, 2025

(54) COMPUTER-READABLE STORAGE MEDIUM, INFORMATION PROCESSING DEVICE, AND METHOD FOR CAUSING PRINTER TO PERFORM PROCESS OTHER THAN NORMAL PRINTING BASED ON ACTIVATION INSTRUCTION

(71) Applicant: BROTHER KOGYO KABUSHIKI KAISHA, Nagoya (JP)

(72) Inventors: Kenju NARITA, Nagoya (JP); Yoshito HOSOMIZO, Konan (JP)

(21) Appl. No.: 18/901,184

(22) Filed: Sep. 30, 2024

Related U.S. Application Data
(63) Continuation of application No. PCT/JP2023/011792, filed on Mar. 24, 2023.

(30) Foreign Application Priority Data
Mar. 30, 2022 (JP) 2022-055381

(51) Int. Cl. G06F 3/12

(52) U.S. Cl. CPC G06F 3/1253; G06F 3/1205

(57) ABSTRACT

A non-transitory computer-readable storage medium stores computer-readable instructions that are executable by a computer of an information processing device and compatible with a particular printer. The computer-readable instructions realize a support program that supports a general-purpose print program incorporated in advance in an operating system of the information processing device. The support program is configured to, when executed by the computer, cause the information processing device to, in response to receiving a processing request from the general-purpose print program when the operating system has received an activation instruction to activate the support program with the particular printer selected, obtain main body information of the particular printer from the particular printer, and send to the particular printer a main body command to cause the particular printer to perform a process based on the obtained main body information.

### REFERENCE TO RELATED APPLICATIONS

This application is a continuation of PCT International Application No. PCT/JP2023/011792 filed on Mar. 24, 2023, and claims priority from Japanese Patent Application No. 2022-055381 filed on Mar. 30, 2022, which are incorporated herein by reference in their entirety.

### BACKGROUND ART

In recent years, a technology has been put to practical use in which a printer is controlled by a general-purpose print program that is incorporated as standard into an operating system (hereinafter referred to as an “OS”) of an information processing device, without using a printer driver. In this technology, the OS associates the printer with the OS-standard general-purpose print program in response to detecting the printer, and thereafter, the information processing device is enabled to cause the printer to perform printing with the OS-standard general-purpose print program without using a printer driver in response to receiving a print instruction to the printer.

In addition, a printer has been known that is configured to print a test pattern in response to receiving a test printing instruction through an operation interface of the printer, as a process executable by the printer other than normal printing. Further, a technology, although known as printer driver technology, has been known in which a printer driver outputs a command for controlling a printer to perform a process specific to the printer, as a process executable by the printer other than normal printing to be performed based on a print instruction from an application program.

### SUMMARY

As described above, there are special processes such as test printing and cleaning as processes executable by a printer other than normal printing, and technologies for instructing the printer to perform such special processes through an operation interface of the printer or a printer driver have been known. Even in an environment where an OS-standard general-purpose print program is used, it is desired that an information processing device be configured to provide instructions to cause the printer to perform such special processes in addition to normal printing to be performed based on a print instruction from an application program. However, the OS-standard general-purpose print program does not have an interface for receiving such instructions. Therefore, there is room for improvement of a configuration to receive such instructions.

According to aspects of the present disclosure, a non-transitory computer-readable storage medium is provided, which stores computer-readable instructions that are executable by a computer of an information processing device and compatible with a particular printer. The computer-readable instructions realize a support program that supports a general-purpose print program incorporated in advance in an operating system of the information processing device. The support program is configured to, when executed by the computer, cause the information processing device to, in response to receiving a particular processing request from the general-purpose print program when a print instruction to cause the particular printer to print a target image has been output from an application program incorporated in the information processing device to the general-purpose print program, obtain image data representing the target image from the general-purpose print program, and send a print command based on the obtained image data to the particular printer. The support program is further configured to, when executed by the computer, cause the information processing device to, in response to receiving a specific processing request from the general-purpose print program when the operating system has received an activation instruction to activate the support program with the particular printer selected, obtain main body information of the particular printer from the particular printer, and send to the particular printer a main body command to cause the particular printer to perform a process based on the obtained main body information.

According to aspects of the present disclosure, further provided is an information processing device that includes a communication interface and a controller. The controller includes a computer and a non-transitory computer-readable storage medium. The non-transitory computer-readable storage medium stores a general-purpose print program incorporated in advance in an operating system of the information processing device. The non-transitory computer-readable storage medium further stores computer-readable instructions realizing a support program that is compatible with a particular printer and supports the general-purpose print program. The support program is configured to, when executed by the computer, cause the controller to, in response to receiving a particular processing request from the general-purpose print program when a print instruction to cause the particular printer to print a target image has been output from an application program incorporated in the information processing device to the general-purpose print program, obtain image data representing the target image from the general-purpose print program, and send a print command based on the obtained image data to the particular printer via the communication interface. The support program is further configured to, when executed by the computer, cause the controller to, in response to receiving a specific processing request from the general-purpose print program when the operating system has received an activation instruction to activate the support program with the particular printer selected, obtain main body information of the particular printer from the particular printer via the communication interface, and send a main body command to cause the particular printer to perform a process based on the obtained main body information, to the particular printer via the communication interface.

According to aspects of the present disclosure, further provided is a method implementable by a computer executing computer-readable instructions on an information processing device. The computer-readable instructions realize a support program that is compatible with a particular printer and supports a general-purpose print program incorporated in advance in an operating system of the information processing device. The method includes performing, in response to receiving a particular processing request from the general-purpose print program when a print instruction to cause the particular printer to print a target image has been output from an application program incorporated in the information processing device to the general-purpose print program, obtaining image data representing the target image from the general-purpose print program, and sending a print command based on the obtained image data to the particular printer. The method further includes performing, in response to receiving a specific processing request from the general-purpose print program when the operating system has received an activation instruction to activate the support program with the particular printer selected, obtaining main body information of the particular printer from the particular printer, and sending to the particular printer a main body command to cause the particular printer to perform a process based on the obtained main body information.

### BRIEF DESCRIPTION OF DRAWINGS

FIG. 1 is a block diagram schematically showing an electrical configuration of a personal computer (hereinafter referred to as a “PC”) connected with a printer.

FIG. 2 is a sequence diagram showing an example procedure including operations and processes by auxiliary programs.

FIG. 3A shows an example of a device setting screen.

FIG. 3B shows an example of a device management screen.

FIG. 4 shows an example of a detailed management screen.

FIG. 5 shows an example of an instruction reception screen.

FIG. 6 is a sequence diagram showing an example procedure including operations and processes by the auxiliary programs.

FIG. 7 is a sequence diagram showing an example of a printing procedure including operations and processes by the auxiliary programs.

### DESCRIPTION

It is noted that various connections are set forth between elements in the following description. It is noted that these connections in general and, unless specified otherwise, may be direct or indirect and that this specification is not intended to be limiting in this respect. Aspects of the present disclosure may be implemented on circuits (such as application specific integrated circuits) or in computer software as programs storable on computer-readable media including but not limited to RAMs, ROMs, flash memories, EEPROMs, CD-media, DVD-media, temporary storage, hard disk drives, floppy drives, permanent storage, and the like.

In the present disclosure, an inclusive OR, meaning that it includes either A or B or both, may be expressed as “A and/or B,” “at least one of A or B,” or “at least one selected from the group consisting of A and B.” The same applies to a case where there are three or more selectable elements to consider.

A detailed explanation will be provided below of a personal computer (hereinafter referred to as a “PC”) using auxiliary programs in an illustrative embodiment according to aspects of the present disclosure, with reference to the accompanying drawings.

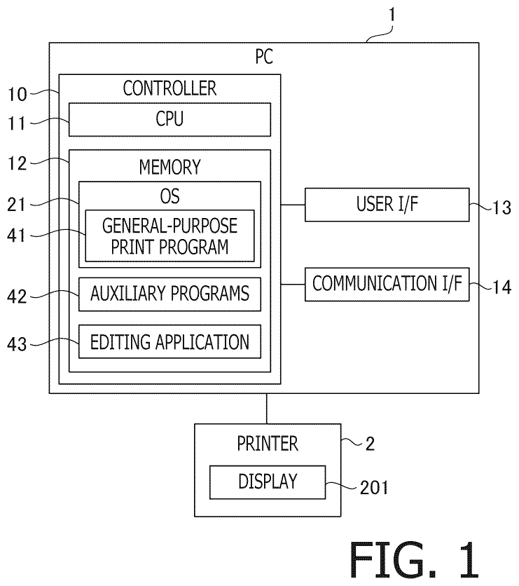

As shown in FIG. 1, a PC 1 of the illustrative embodiment has a controller 10 that includes a CPU 11 and a memory 12. The PC 1 may be an example of an “information processing device” according to aspects of the present disclosure. The CPU 11 may be an example of a “computer” according to aspects of the present disclosure. The PC 1 further includes a user interface (hereinafter referred to as a “user I/F”) 13 and a communication interface (hereinafter referred to as a “communication I/F”) 14, which are electrically connected with the controller 10. The “controller 10” in FIG. 1 is a collective term for hardware and software used to control the PC 1, and may not necessarily represent a single hardware element actually existing in the PC 1.

The CPU 11 is configured to perform various processes according to programs read from the memory 12 and based on user operations. The memory 12 stores various types of data and various programs. The memory 12 is also used as a work area when various processes are performed. A buffer provided to the CPU 11 may be an example of a “memory” according to aspects of the present disclosure. Examples of the memory 12 are not limited to a ROM, a RAM, and an HDD that are incorporated in the PC 1, but may include storage media (e.g., CD-ROMs and DVD-ROMs) that are readable and writable by the CPU 11.

The user I/F 13 includes hardware configured to display screens to provide information to the user, and hardware configured to receive user operations. The user I/F 13 may have a combination of a display configured to display information (i.e., having a display function), and a mouse and/or a keyboard that are configured to accept user input operations (i.e., having an input acceptance function). The user I/F 13 may include a touch panel having the display function and the input acceptance function.

The communication I/F 14 includes hardware configured to communicate with external devices such as the printer 2. Communication standards applicable for the communication I/F 14 include Ethernet (“Ethernet” is a registered trademark of Fuji Xerox Co., Ltd.), Wi-Fi (“Wi-Fi” is a registered trademark of the non-profit Wi-Fi Alliance), and USB. The PC 1 may be configured to connect with the Internet via the communication I/F 14. The PC 1 may have a plurality of communication I/Fs 14 conforming to a plurality of communication standards. As shown in FIG. 1, the PC 1 in the illustrative embodiment is connected with the printer 2 via the communication I/F 14. The printer 2 has at least a printing function and a communication function.

As shown in FIG. 1, the memory 12 of the PC 1 stores an operating system (hereinafter referred to as an “OS”) 21 that includes a general-purpose print program 41, auxiliary programs 42, and various application programs (hereinafter referred to as “applications”) such as an editing application 43. Examples of the OS 21 may include, but are not limited to, Windows (“Windows” is a registered trademark of Microsoft Corporation), macOS (“macOS” is a registered trademark of Apple Inc.), Linux (“Linux” is a registered trademark of Linus Torvalds), iOS (“iOS” is a registered trademark of Cisco Systems, Inc.), and Android (“Android” is a registered trademark of Google LLC). The auxiliary programs 42 may be an example of a “support program” according to aspects of the present disclosure, and may be an example of “computer-readable instructions” according to aspects of the present disclosure.

The general-purpose print program 41 is an OS-standard program provided with the OS 21 and has a function to cause the printer 2 to perform printing. The general-purpose print program 41 in the illustrative embodiment is a program having a function for generating intermediate image data based on image data to be printed. The general-purpose print program 41 supports functions that are usable in common by a plurality of printer models provided by vendor(s) of various printers. Unlike printer drivers that are specific to individual printers, the general-purpose print program 41 does not support all of the functions that are unique to the individual printers. Functions supportable by the general-purpose print program 41 are limited to generic functions.

The auxiliary programs 42 include one program or a group of programs that support control of target hardware elements. The auxiliary programs 42 in the illustrative embodiment are compatible with a model of the printer 2 connected with the PC 1. The auxiliary programs 42 are launched from the general-purpose print program 41, for instance, when the PC 1 has received an instruction to cause the printer 2 to perform printing using the general-purpose print program 41. The auxiliary programs 42 are called, for instance, PSA (“PSA” is an abbreviation for “Print Support Application”) or HSA (“HSA” is an abbreviation for “Hardware Support Application”).

For instance, the auxiliary programs 42 may include a combination of a plurality of programs each of which is configured to, when executed by the CPU 11, cause the PC 1 to accept execution instructions. In another instance, the auxiliary programs 42 may include one program configured to, when executed by the CPU 11, cause the PC 1 to accept instructions and perform respective different processes according to the accepted instructions. The auxiliary programs 42 may include a program prepared for each type of printer by the printer vendor(s). For instance, the auxiliary programs 42 may include an auxiliary program prepared for inkjet printers and an auxiliary program prepared for laser printers. The auxiliary programs 42 may include not only the auxiliary program prepared for each type of printer but also an auxiliary program prepared for each model of printer or an auxiliary program prepared for each series of models of printers.

For instance, when a new printer is connected with the PC 1, the OS 21 may cause the PC 1 to download an appropriate auxiliary program from a server or another source depending on a type of the connected printer and to incorporate the downloaded auxiliary program into the PC 1. Then, the OS 21 may cause the PC 1 to store identification information of the incorporated auxiliary program in the memory 12 in association with printer information of the newly connected printer, and to create a printer queue for each printer.

The editing application 43 is, for instance, an application for creating or editing image data or document data. The editing application 43 may be, for instance, Microsoft Word (“Microsoft Word” is a registered trademark of Microsoft Corporation) or PowerPoint (“PowerPoint” is a registered trademark of Microsoft Corporation) made by Microsoft (“Microsoft” is a registered trademark of Microsoft Corporation), or an application provided by the vendor of the printer 2. The editing application 43 is configured to accept, for instance, a print execution instruction to cause the printer 2 to perform printing via the user I/F 13.

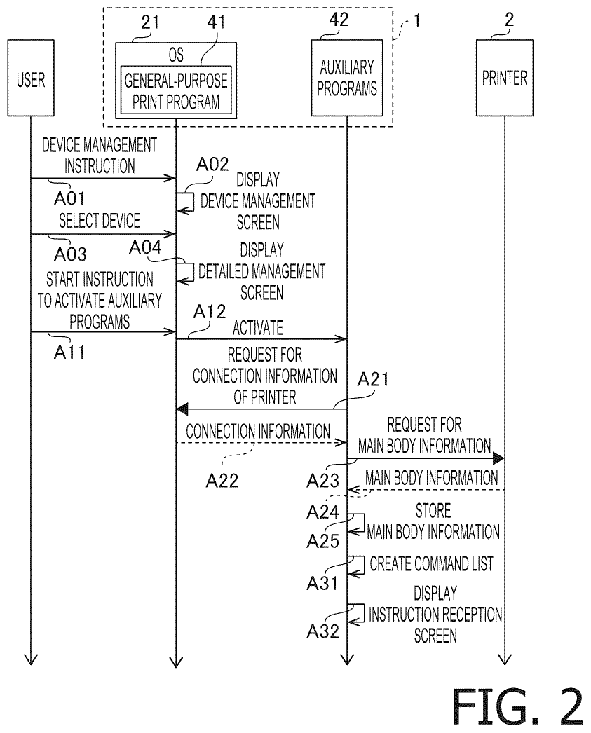

Next, a procedure of operations and processes by the OS 21 and the auxiliary programs 42 in the illustrative embodiment will be described with reference to a sequence diagram shown in FIG. 2. This procedure is implemented in a state where the printer 2 is connected with the PC 1 and the auxiliary programs 42 compatible with the printer 2 are stored in the memory 12.

Each processing step in the illustrative embodiment basically indicates processing by the CPU 11 according to instructions described in programs such as the auxiliary programs 42. The processing by the CPU 11 includes hardware control using an API (“API” is an abbreviation for “Application Programming Interface”) of the OS 21. In the present disclosure, operations and processes by the individual programs may be described without a detailed explanation of the OS 21. It is noted that “obtaining” and “acquiring” may be used as concepts that do not necessarily require a request.

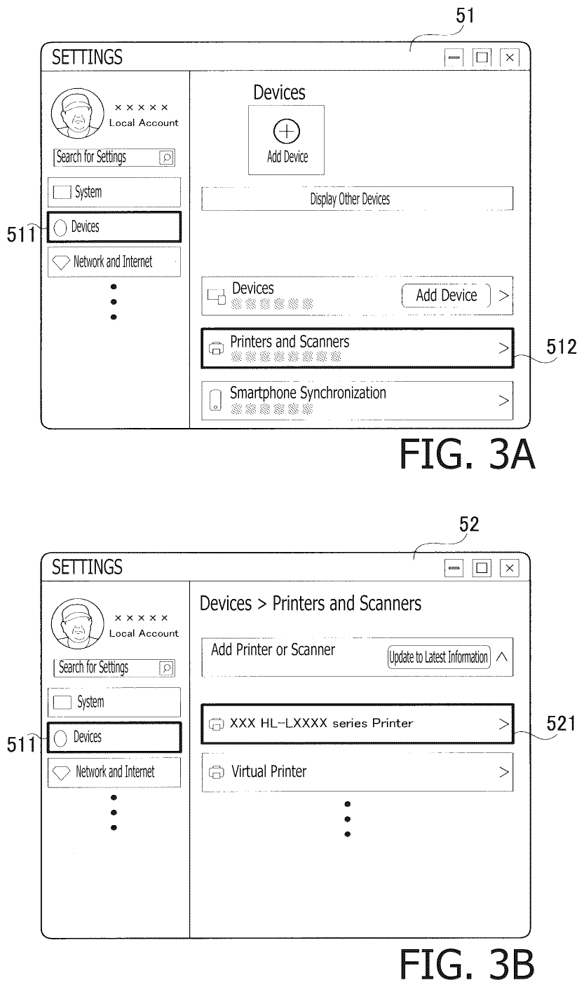

The OS 21 is configured to accept a setting instruction for each element included in the PC 1 from the user. The OS 21 is further configured to accept, on a screen for accepting setting instructions, device management instructions that include instructions to display information about various devices connected with the PC 1 and instructions to change settings for the various devices. For instance, when the OS 21 has received a setting instruction and a device management instruction (A01), the OS 21 is enabled to further accept device selection, e.g., as shown in FIGS. 3A and 3B. For instance, when the OS 21 has accepted an operation on a “Printers and Scanners” button 512 on a device setting screen 51 (see FIG. 3A) displayed in response to accepting an operation on a “Devices” button 511, the OS 21 displays a device management screen 52, e.g., as shown in FIG. 3B (A02).

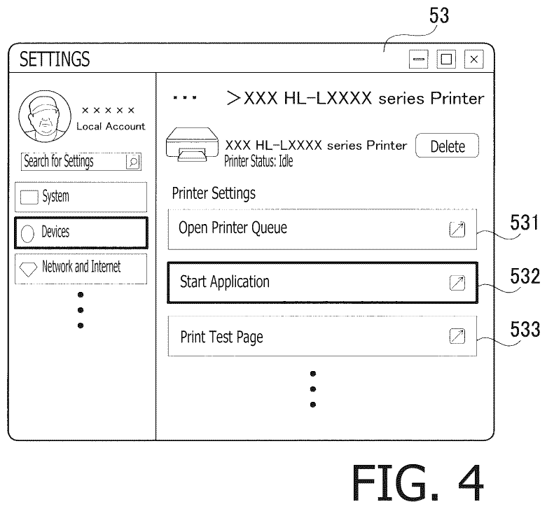

The device management screen 52 includes a list of various devices (e.g., printers and scanners) connected with the PC 1 and configured to perform image processing. The user may select a target device to be managed from the list displayed on the device management screen 52 (A03). For instance, in response to accepting an operation on a button 521 for specifying the printer 2 on the device management screen 52, the OS 21 displays a detailed management screen 53, e.g., as shown in FIG. 4 (A04).

The detailed management screen 53 is configured to display thereon an “Open Printer Queue” button 531, a “Start Application” button 532, and a “Print Test Page” button 533. The “Open Printer Queue” button 531 is configured to, when operated, accept an instruction to check a status of a printer queue corresponding to the selected printer. The “Start Application” button 532 is configured to, when operated, accept a start instruction (hereinafter, which may be referred to as an “activation instruction”) to activate a program corresponding to the selected printer. The “Print Test Page” button 533 is configured to, when operated, accept an instruction to send a test image provided by the OS 21 to the selected printer. The OS 21 is enabled to accept user operations on the buttons 531, 532, and 533 on the detailed management screen 53.

When the OS 21 has received a start instruction to activate a corresponding program in response to an operation on the “Start Application” button 532 on the detailed management screen 53 displayed with the printer 2 selected (A11), the OS 21 passes information on the selected printer 2, and the start instruction to activate the program corresponding to the printer 2 to the general-purpose print program 41. The general-purpose print program 41 is configured to activate the program associated with the printer information of the printer 2 in response to receiving the start instruction from the OS 21. In the illustrative embodiment, the identification information of the auxiliary programs 42 is stored in association with the printer information of the printer 2. Therefore, in this case, the general-purpose print program 41 activates the auxiliary programs 42 (A12).

When activated from the general-purpose print program 41 in response to the user's start instruction, the auxiliary programs 42 obtain main body information of the printer 2 via the OS 21. The auxiliary programs 42 first send a request for connection information of the printer 2 to the OS 21 (A21), and then obtain the connection information from the OS 21 (A22). Examples of the connection information may include, but are not limited to, an IP address.

The auxiliary programs 42 send a request for the main body information to the printer 2 using the connection information obtained in A22 (A23), and obtain the main body information from the printer 2 (A24). The main body information includes capability information indicating capabilities of the printer 2. The main body information may further include information indicating a status of a main body of the printer 2.

For instance, the capability information may include information indicating functions executable by the printer 2 and/or information on parameters configurable as print settings. The information indicating the status of the main body of the printer 2 may include, for instance, status information, information on remaining amounts of consumables, information indicating accessories such as optional trays installed, information on a sheet size and a sheet type set for each tray, information on main body settings such as a language used and on network settings, information on a firmware version, information on a print history, and the number of print jobs on standby.

The printer 2 in the illustrative embodiment includes an operation panel. The operation panel of the printer 2 includes a display 201 (see FIG. 1) for displaying information, and operable buttons for accepting user input operations. The operation panel may include a touch panel having functions of the display 201. The printer 2 is configured to display information about the printer 2 on the display 201 and to accept various instructions in response to input operations on the operation panel.

The printer 2 is further configured to accept, via the operation panel, change instructions for some of the setting values set for the printer 2. For instance, in response to receiving, via the operation panel, a change instruction to change the sheet size or the sheet type for each tray, or a change instruction to change the network settings, the printer 2 displays selectable setting values on the display 201, and accepts a user's selection from among the selectable setting values displayed on the display 201. On the other hand, the setting values set for the printer 2 include a setting value that is not displayed on the operation panel and a setting value for which a change instruction is not accepted via the operation panel. For instance, the printer 2 may be configured to not display information about restrictions on access to the printer 2 or information about the print history on the display 201.

In response to the request for the main body information in A23, the printer 2 passes information that is displayed on the display 201 and information that is not displayed on the display 201 to the auxiliary programs 42. Namely, in A24, the auxiliary programs 42 may obtain, as the main body information, both information that is displayed on the display 201, such as various settings received via the operation panel of the printer 2, and information that is not displayed on the display 201, such as various settings received through instructions from an external device.

The printer 2 may have functions to perform image processing based on a received print job and perform printing based on data obtained after the image processing, e.g., functions to perform aggregate printing such as N in 1, composition printing such as printing an image combined with a watermark, and saving printing to save colorant. When the printer 2 has image processing functions executable thereon, the printer 2 may pass information on the image processing functions to the auxiliary programs 42 as main body information.

The auxiliary programs 42 may obtain information directly from the printer 2, for instance, using an MIB (“MIB” is abbreviation for “Management Information Base”), thereby obtaining information that is not understood by the OS 21. The auxiliary programs 42 store the information obtained from the printer 2 in the memory 12 (A25).

The auxiliary programs 42 may send an obtainment request for the main body information of the printer 2 to the OS 21, instead of the request for connection information of the printer 2 in A21. In this case, the OS 21 obtains the requested information from the printer 2, for instance, through communication according to an IPP (“IPP” is an abbreviation for “Internet Printing Protocol”), and passes the obtained information to the auxiliary programs 42. The auxiliary programs 42 may perform both sending the obtainment request for the main body information to the OS 21 and obtaining the main body information through direct communication with the printer 2.

The auxiliary programs 42 create a command list based on the main body information obtained in A24 (A31). The command list is a list of processes that are executable by the printer 2 in response to commands sent from the PC 1. The auxiliary programs 42 determine commands to be included in the command list based on the main body information of the printer 2. Specifically, based on the capability information of the printer 2, the auxiliary programs 42 include in the command list only commands that are executable by the printer 2, and do not include commands that are not executable by the printer 2.

For instance, when the printer 2 is configured to perform color printing, the auxiliary programs 42 create a command list that includes a test printing command to cause the printer 2 to print an image for color shift adjustment. Meanwhile, when the printer 2 is not configured to perform color printing, the auxiliary programs 42 create a command list that does not include such a test printing command to cause the printer 2 to print an image for color shift adjustment. Further, for instance, when the printer 2 is an inkjet printer, the auxiliary programs 42 create a command list that includes a print command to cause the printer 2 to print a nozzle check pattern. Meanwhile, when the printer 2 is a laser printer, the auxiliary programs 42 create a command list that does not include such a print command to cause the printer 2 to print a nozzle check pattern.

Further, for instance, when the printer 2 is configured to perform borderless printing, the auxiliary programs 42 create a print command list that includes a command to cause the printer 2 to print a borderless adjustment pattern. Further, for instance, when the printer 2 is configured to perform ruled line printing, the auxiliary programs 42 create a command list that includes a print command to cause the printer 2 to print a ruled line adjustment pattern. Further, for instance, when the printer 2 is configured to accept selection of a red color tone, the auxiliary programs 42 create a command list that includes a print command to cause the printer 2 to print a catalog of red color patches.

It is useless to send commands to cause the printer 2 to perform processes that are not executable by the printer 2. The auxiliary programs 42 in the illustrative embodiment identify processes that are executable by the printer 2 and create the command list that includes only the identified processes that are executable by the printer 2, thus avoiding such a useless operation. The auxiliary programs 42 may determine the commands to be included in the command list based on model information of the printer 2.

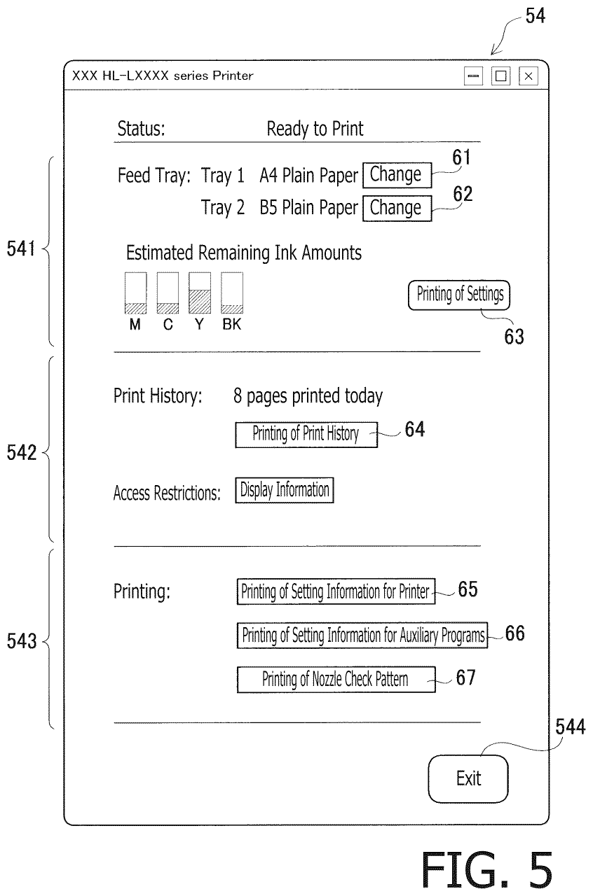

Further, based on the created command list, the auxiliary programs 42 cause the user I/F 13 to display an instruction acceptance screen 54, for instance, as shown in FIG. 5 (A32). The instruction acceptance screen 54 is configured to display information about the printer 2, including some of the main body information obtained in A24. The instruction acceptance screen 54 includes buttons for accepting output instructions to output commands included in the command list created in A31.

Specifically, the instruction reception screen 54 includes a first display area 541, a second display area 542, and a third display area 543. The first display area 541 includes information displayed on the display 201 of the printer 2. Specifically, for instance, the first display area 541 is configured to display a setting status of each feed tray of the printer 2, and an estimated remaining amount of each type of ink. The first display area 541 includes buttons 61 and 62 for accepting changes in the settings for the individual feed trays. The first display area 541 further includes a button 63 for accepting a setting print instruction. The second display area 542 includes information that is not displayed on the display 201 of the printer 2. Specifically, for instance, the second display area 542 is configured to display a part of the print history. The second display area 542 includes a button 64 for accepting an instruction to print the print history. The third display area 543 includes information corresponding to commands included in the command list. Specifically, for instance, the third display area 543 includes buttons 65, 66, and 67 for accepting instructions to perform various types of test printing based on the command list.

The auxiliary programs 42 may require user authentication before displaying information in the second display area 542. The information that is not displayed on the display 201 of the printer 2 display 201 may be highly confidential. For instance, in A32, the auxiliary programs 42 may display the first display area 541 and the third display area 543, and may display a screen for accepting input of authentication information in response to a user's request to display the second display area 542. In this case, the auxiliary programs 42 may send the accepted authentication information to the printer 2, and cause the printer 2 to perform user authentication. Then, the auxiliary programs 42 may display information in the second display area 542 when it is determined in the user authentication by the printer 2 the user is the administrator of the printer 2.

The instruction reception screen 54 may be further configured to display various types of main body information such as the status information, network information, and firmware version information of the printer 2. The instruction reception screen 54 may further include a button for accepting a display instruction to display detailed information. The instruction reception screen 54 may further include an exit button 544 for accepting an instruction to terminate the display of the instruction reception screen 54.

The auxiliary programs 42 in the illustrative embodiment cause the user I/F 13 to display the instruction reception screen 54 that includes the main body information obtained from the printer 2. Therefore, the user is allowed to view the main body information of the printer 2 only by operating the “Start Application” button 532 (see FIG. 4) to provide the start instruction. In addition, the auxiliary programs 42 in the illustrative embodiment allow information that is not displayed on the display 201 of the printer 2 to be displayed on the user I/F 13. Thus, the auxiliary programs 42 cause the user I/F 13 to display highly valuable information for use. Further, the auxiliary programs 42 cause the user I/F 13 to display information on the command list of commands compatible with the printer 2 based on the start instruction input by an operation on the “Start Application” button 532 (see FIG. 4). Therefore, the user is allowed to provide the printer 2 with an instruction to perform appropriate test printing.

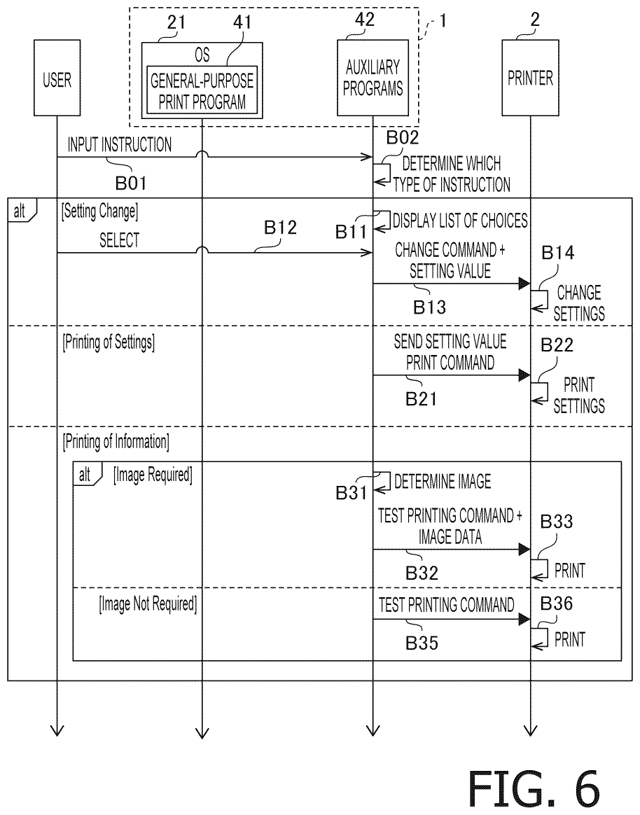

The auxiliary programs 42 are then ready to accept operations on the instruction reception screen 54 being displayed. Namely, at this time, the user may operate any button displayed on the instruction reception screen 54. A procedure of operations and processes by the individual programs when an operation on the instruction reception screen 54 has been accepted will be described with reference to a sequence diagram shown in in FIG. 6.

In response to receiving an instruction input by a user operation on one of the buttons displayed on the instruction reception screen 54 (B01), the auxiliary programs 42 determine which type of instruction is the received instruction (B02). Specifically, the auxiliary programs 42 determine which is the received instruction among an instruction to change tray settings, to be input by an operation on one of the buttons 61 and 62, an instruction to print the setting information for the printer 2, to be input by an operation on the button 63, and an instruction to perform test printing of corresponding information, to be input by an operation on one of the buttons 64 to 67. The auxiliary programs 42 in the illustrative embodiment perform a corresponding process in response to receiving a user instruction. Thus, it is possible to avoid execution of an unnecessary process.

For instance, in response to determining that an instruction to change settings for Tray 1 has been received through a user operation on the button 61 included in the first display area 541 (alt: [Setting Change]), the auxiliary programs 42 cause the user I/F 13 to display a list containing setting values settable for Tray 1 as choices (B11), and accept a user's selection from the list (B12).

The auxiliary programs 42 send to the printer 2 a change command, which is an instruction to change the settings for Tray 1, and information on the new setting value selected by the user operation (B13). Based on the received change command, the printer 2 sets the new setting value associated with the change command, as a setting value for Tray 1 (B14).

The auxiliary programs 42 in the illustrative embodiment accept, via the instruction reception screen 54, an instruction to send to the printer 2 the change command to cause the printer 2 to change the setting value. Thus, the user is allowed to cause the printer 2 to change the setting value, based on the start instruction provided by operating the “Start Application” button 532 (see FIG. 4).

In addition, for instance, in response to determining that an instruction to print information on the setting values set for the printer 2 has been received through a user operation on the button 63 included in the first display area 541 (alt: [Printing of Settings]), the auxiliary programs 42 send a setting value print command to the printer 2 (B21).

The printer 2 prints the information on the various setting values for the printer 2 based on the received setting value print command (B22). The printer 2 prints setting values for predetermined items in a format that is previously provided in the printer 2.

The auxiliary programs 42 in the illustrative embodiment receive, via the instruction reception screen 54, an instruction to send to the printer 2 the setting value print command to cause the printer 2 to print the information on the setting values. Thereby, the user is allowed to cause the printer 2 to print the information on the setting values, based on the start instruction provided by operating the “Start Application” button 532 (see FIG. 4).

In addition, for instance, in response to determining that an instruction to print a corresponding type of information has been received through a user operation on the button 64 included in the second display area 542 or on one of the buttons 65 to 67 included in the third display area 543 (alt: [Printing of Information]), the auxiliary programs 42 determine whether the target information to be printed is information of which an image needs to be determined by the auxiliary programs 42.

Instructions to print information include an instruction to cause the printer 2 to print an image (e.g., a test image) provided in the printer 2 as it is, and an instruction to cause the printer 2 to print an image based on information that varies depending on situations or information selected by the user. When the received print instruction is an instruction to cause the printer 2 to print information provided in the printer 2 as it is, the auxiliary programs 42 need only to send a command to print the information to the printer 2. Meanwhile, when the received print instruction is an instruction to cause the printer 2 to print information that varies depending on situations or information selected by the user, the auxiliary programs 42 need to determine a target image to be printed.

For instance, in response to receiving an instruction to print information based on the main body information through an operation on the button 65 included in the third display area 543, the auxiliary programs 42 determine that it is required to determine a target image to be printed (alt: [Image Required]) and determine the target image to be printed (B31). In this case, for instance, the auxiliary programs 42 extract information to be printed from the main body information of the printer 2. Then, based on the extracted information, the auxiliary programs 42 determine, as the target image to be printed, an image in which at least part of the main body information is written.

The auxiliary programs 42 may accept selection of the information to be printed. For instance, in response to accepting an operation on the button 65, the auxiliary programs 42 may display a list of items of information extractable as a print target, and may accept a user's selection from the list. Thus, in this case, it is possible to print only the necessary information.

For instance, in response to receiving an instruction to print information set in the auxiliary programs 42 through an operation on the button 66 included in the third display area 543, the auxiliary programs 42 also determine that it is required to determine an image to be printed (alt: [Image Required]) and determine the image to be printed (B31). In this case, for instance, the auxiliary programs 42 generate an image including the information set in the auxiliary programs 42, and determine the generated image as the image to be printed.

Examples of the information set in the auxiliary programs 42 may include, but are not limited to, default print settings for the auxiliary programs 42, user's profile settings, user name(s), and information on the OS 21. The auxiliary programs 42 may accept selection of information to be printed, and may generate the target image to be printed based on the selected information.

Further, the auxiliary programs 42 send a test printing command and image data representing the image determined in B31 to the printer 2 (B32). Based on the received test printing command, the printer 2 performs test printing to print a test image including the image represented by the received image data (B33).

When the auxiliary programs 42 generate a test image in which at least part of the main body information of the printer 2 is written, and send the generated test image to the printer 2, the user is allowed to know main body information written in a printed image by viewing the printed image. When the auxiliary programs 42 generate a test image in which information about the auxiliary programs 42 is written, and send the generated test image to the printer 2, the user is allowed to know the information about the auxiliary programs 42 written in a printed image by viewing the printed image.

On the other hand, in response to determining that the instruction received in B01 is an instruction to print an image (e.g., a test image) provided in the printer 2 (alt: [Image Not Required]), the auxiliary programs 42 determine a test image to be printed, and send a test printing command specifying the determined test image to the printer 2 (B35). The auxiliary programs 42 may determine the target image to be printed from a plurality of test images. The printer 2 performs test printing to print the specified test image based on the received test printing command (B36).

For instance, in response to receiving an instruction to print a nozzle check pattern through an operation on the button 67 included in the third display area 543, the auxiliary programs 42 send to the printer 2 a test printing command specifying a nozzle check pattern provided in the printer 2. When the received instruction is an instruction to print an image provided in the printer 2, the auxiliary programs 42 need only to specify a target image to be printed, without having to send corresponding image data.

The auxiliary programs 42 in the illustrative embodiment receive a print instruction specifying the target image to be printed for test printing on the instruction reception screen 54. Therefore, the user may cause the printer 2 to print the image including the desired information based on the start instruction input by an operation on the “Start Application” button 532 (see FIG. 4). When the auxiliary programs 42 determine a test image as the target image to be printed and send a test printing command including image data of the determined test image, the printer 2 does not need to prepare the test image to be printed. Thereby, it is possible to save a memory capacity of the printer 2. On the other hand, when the received instruction is an instruction to print an image provided in the printer 2, the auxiliary programs 42 do not need to determine the test image to be printed. Therefore, the processing by the auxiliary programs 42 is simplified.

The auxiliary programs 42 may request user authentication before sending the command, depending on the information specified as the target information to be printed. For instance, when the auxiliary programs 42 have received an instruction to print information on access restrictions for each user and/or authentication information for each user, the auxiliary programs 42 may accept input of authentication information and cause the printer 2 to perform user authentication. For instance, when the auxiliary programs 42 have received an instruction to print information of a specified user other than the user logged in to the PC 1, the auxiliary programs 42 may request input of authentication information and send the command only if the specified user is determined to be the administrator of the printer 2.

The auxiliary programs 42 may be configured to accept an instruction to update firmware incorporated in the printer 2 on the instruction reception screen 54. For instance, in an attempt to perform printing using the printer 2, the auxiliary programs 42 may obtain information on the latest version of the firmware, e.g., from a printer manufacturer's server and store the obtained information in the memory 12. Then, in response to determining that the firmware of the printer 2 is not the latest version based on the main body information obtained in A24, the auxiliary programs 42 may display on the instruction reception screen 54 a button for accepting an instruction to update the firmware.

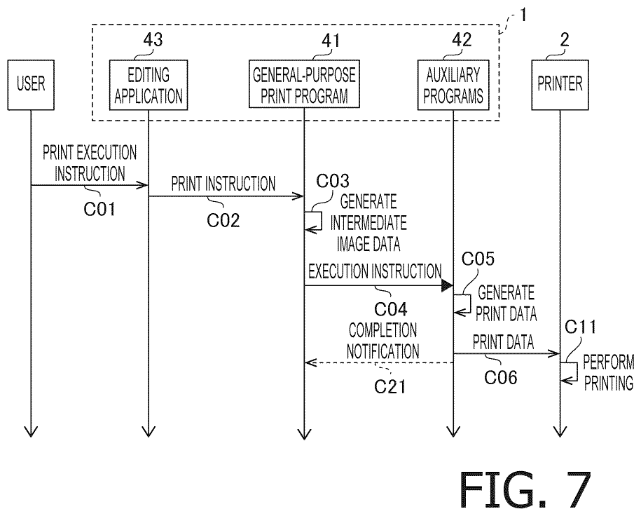

Next, a printing procedure including operations and processes by the auxiliary programs 42 in the illustrative embodiment will be described with reference to a sequence diagram shown FIG. 7. The auxiliary programs 42 are also executed when a user instruction to cause the printer 2 to perform printing has been provided to the general-purpose print program 41. The user is allowed to perform, e.g., using the editing application 43, selecting a target image to be printed, specifying a printer to be used for printing, and providing an instruction to cause the specified printer to print the selected target image. FIG. 7 shows operations and processes by the individual programs when the editing application 43 receives a user instruction to cause the printer 2 to perform printing. The user instruction to cause the printer 2 to perform printing may be input directly to the general-purpose print program 41.

In response to receiving a print execution instruction to cause the printer 2 to print a selected image (i.e., a target image to be printed) as an instruction to the general-purpose print program 41 (C01), the editing application 43 passes a print instruction to the general-purpose print program 41 via the OS 21 (C02). The general-purpose print program 41 obtains information indicating image data of the target image to be printed and information indicating the print settings from the received print instruction.

The general-purpose print program 41 generates intermediate image data by converting a format of the image data included in the received print instruction to a format of intermediate image data (C03). The general-purpose print program 41 then generates a print job including the intermediate image data. Image data to be passed from the editing application 43 to the general-purpose print program 41 may include various types of image data. The general-purpose print program 41 converts the received image data into intermediate image data suitable for generating print data. If the image data included in the print instruction is suitable for generating print data, the general-purpose print program 41 does not need to generate the intermediate image data. Namely, in this case, the general-purpose print program 41 may use the image data included in the print instruction as the intermediate image data as is. Examples of the intermediate image data may include, but are not limited to, XPS data.

The general-purpose print program 41 further outputs an execution instruction to the auxiliary programs 42 compatible with the printer 2 (C04), and sends a request for processing to the auxiliary programs 42. Through the execution instruction, the intermediate image data generated in C03 and the information indicating the print settings are passed to the auxiliary programs 42.

The auxiliary programs 42 perform rasterization based on the received intermediate image data and the received print settings, thereby generating print data (C05). The print data generated in C05 is data in a format usable for printing by the printer 2. For instance, the print data generated in C05 is PDL data dedicated to the model of the printer 2. The auxiliary programs 42 may execute C05 using the main body information obtained in A24. In addition, the auxiliary programs 42 may obtain the main body information from the printer 2 again before C05.

When the processed intermediate image data is rasterized by the auxiliary programs 42 compatible with the printer 2, the rasterization is achieved with a higher degree of freedom and it is more likely that print data suitable for printing by the printer 2 is generated than when rasterized by the general-purpose print program 41. The print data generated by the auxiliary programs 42 may be in a format usable for printing by printers other than the model of the printer 2.

Instead of the auxiliary programs 42 generating the print data, the general-purpose print program 41 may generate the print data. Namely, the auxiliary programs 42 may pass the intermediate image data, the information on the print settings, and print execution information to the general-purpose print program 41. The general-purpose print program 41 may generate the print data based on the intermediate image data and the print settings received from the auxiliary programs 42, and pass the generated print data to the auxiliary programs 42. In response to receiving the print data from the general-purpose print program 41, the auxiliary programs 42 may send the print data received from the general-purpose print program 41 to the printer 2 together with a print command for instructing the printer to perform printing.

The print data generated by the general-purpose print program 41 is print data (e.g., PWG Raster data or PDF data) in a format usable for printing by various types of printers. If the print data is generated by the general-purpose print program 41, it results in a smaller amount of processing by the auxiliary programs 42, thereby avoiding an increase in processing time, and reducing a program size of the auxiliary programs 42.

The general-purpose print program 41 may send the print data to the printer 2. Namely, the auxiliary programs 42 may pass the generated print data to the general-purpose print program 41, to be sent from the PC 1 with the printer 2 as a destination. In this case, the general-purpose print program 41 may send the print data received from the auxiliary programs 42 to the printer 2 via the OS 21.

The printer 2 may be configured to rasterize the intermediate image data. In such a case, the auxiliary program 42 may send a print command including the intermediate image data of the target image to be printed and the print settings to the printer 2 without generating the print data of the target image to be printed.

After completion of sending the print data, the auxiliary programs 42 send to the general-purpose print program 41 a completion notification that the processing based on the execution instruction received in C04 has been completed (C21). Thus, the general-purpose print program 41 completes the processing based on the print instruction received in C02. The general-purpose print program 41 may send to the editing application 43 a notification that the processing based on the print instruction received in C02 has been completed.

As described in detail above, apart from the print instruction from the editing application 43, in response to an activation instruction (i.e., the start instruction to activate the auxiliary programs 42) being received by the OS 21, the auxiliary programs 42 in the illustrative embodiment obtain the main body information of the printer 2 that is the selected printer, and send to the printer 2 a main body command that instructs the printer 2 to perform a process based on the main body information. Thereby, the user is allowed to instruct the printer 2 to perform a process other than normal printing based on the print instruction, based on an operation to input the activation instruction.

While aspects of the present disclosure have been described in conjunction with various example structures outlined above and illustrated in the drawings, various alternatives, modifications, variations, improvements, and/or substantial equivalents, whether known or that may be presently unforeseen, may become apparent to those having at least ordinary skill in the art. Accordingly, the example embodiment(s), as set forth above, are intended to be illustrative of the technical concepts according to aspects of the present disclosure, and not limiting the technical concepts. Various changes may be made without departing from the spirit and scope of the technical concepts according to aspects of the present disclosure. Therefore, the disclosure is intended to embrace all known or later developed alternatives, modifications, variations, improvements, and/or substantial equivalents. Some specific examples of potential alternatives, modifications, or variations according to aspects of the present disclosure are provided below.

For instance, the device connected with the PC 1 is not limited to printer 2, but may be any device (e.g., multi-function peripherals, copiers, and fax machines) having a printing function. The number of printers 2 connected with the PC 1 is not limited to the example (i.e., one) shown in the relevant drawings, but may be two or more.

The images shown in FIGS. 3A, 3B, 4, and 5 are examples, and practicable examples thereof are not limited to the illustrated examples. Examples of the shapes, locations, and backgrounds of the words and objects displayed in the notification images are not limited to the illustrated examples, but may include any other practicable examples. Examples of the various types of information displayed are not limited to the illustrated examples, but may include any other practicable types.

The auxiliary programs 42 in the aforementioned illustrative embodiment are configured to accept an instruction for selecting a command to cause the printer 2 to perform a corresponding process. However, the auxiliary programs 42 may not be configured to accept such an instruction. For instance, the auxiliary programs 42 may be configured to automatically send a predetermined main body instruction when activated by an activation instruction in response to an operation on the “Start Application” button 532 (see FIG. 4). However, it is useless to send a main body instruction for a process that is not required to be performed. The auxiliary programs 42 in the aforementioned illustrative embodiment perform a corresponding process in response to receiving a user instruction. Therefore, it is possible to avoid execution of a useless process.

For instance, the auxiliary programs 42 may be configured to perform another process in addition to obtaining the main body information and sending the main body command, when activated by an activation instruction in response to an operation on the “Start Application” button 532 (see FIG. 4). The auxiliary programs 42 may be configured to perform another process even if an instruction to output the main body instruction is not input.

The auxiliary programs 42 in the aforementioned illustrative embodiment are configured to generate a test image including the main body information of the printer 2 and/or information on the auxiliary programs 42. However, the auxiliary programs 42 may not be configured to generate such a test image. For instance, the auxiliary programs 42 may not send image data when sending a test printing command.

Examples of the program to perform the processing in the aforementioned illustrative embodiment are not limited to the auxiliary programs 42, but may include any program configured to accept instructions from the OS 21 or the general-purpose print program 41 when printing is performed using the general-purpose print program 41. For instance, a print workflow application (Print workflow) whose specifications have been published by Microsoft Corp. may be included in the examples of the program to perform the processing in the aforementioned illustrative embodiment.

Practicable examples of the execution timing for executing the auxiliary programs 42 are not limited to the example in the aforementioned illustrative embodiment. For instance, the auxiliary programs 42 may be executed in response to a direct execution instruction from the OS 21. In another instance, the auxiliary programs 42 may be resident programs. In this case, the auxiliary programs 42 may perform the aforementioned operations in response to receiving execution commands.

In any flowchart disclosed in the aforementioned illustrative embodiment, a plurality of processes in a plurality of any steps may be arbitrarily changed in the execution order thereof or may be executed in parallel as long as there is no inconsistency in the processing results.

The processing disclosed in the aforementioned illustrative embodiment may be performed by one or more CPUs, one or more hardware elements such as ASICs, or a combination of at least two selected therefrom. The processing disclosed in the aforementioned illustrative embodiment may be implemented in various aspects such as a non-transitory computer-readable storage medium storing computer-readable instructions (e.g., programs) for performing the processing, or a method for performing the processing.

The following shows examples of associations between elements illustrated in the aforementioned illustrative embodiment(s) and modification(s), and elements claimed according to aspects of the present disclosure. For instance, the PC 1 may be an example of an “information processing device” according to aspects of the present disclosure. The CPU 11 may be an example of a “computer” according to aspects of the present disclosure. The controller 10 may be an example of a “controller” according to aspects of the present disclosure. The memory 12 may be an example of a “non-transitory computer-readable storage medium” according to aspects of the present disclosure. The communication I/F 14 may be an example of an “communication interface” according to aspects of the present disclosure. The printer 2 may be an example of a “particular printer” according to aspects of the present disclosure. The auxiliary programs 42 may be an example of a “support program” according to aspects of the present disclosure. The general-purpose print program 41 may be an example of a “general-purpose print program” according to aspects of the present disclosure. The OS 21 may be an example of an “operating system” according to aspects of the present disclosure. The editing application 43 may be an example of an “application program” according to aspects of the present disclosure.

What is claimed is:

1. A non-transitory computer-readable storage medium storing computer-readable instructions that are executable by a computer of an information processing device and compatible with a particular printer, the computer-readable instructions realizing a support program that supports a general-purpose print program incorporated in advance in an operating system of the information processing device, the support program being configured to, when executed by the computer, cause the information processing device to:
in response to receiving a particular processing request from the general-purpose print program when a print instruction to cause the particular printer to print a target image has been output from an application program incorporated in the information processing device to the general-purpose print program, obtain image data representing the target image from the general-purpose print program, and send a print command based on the obtained image data to the particular printer; and
in response to receiving a specific processing request from the general-purpose print program when the operating system has received an activation instruction to activate the support program with the particular printer selected, obtain main body information of the particular printer from the particular printer, and send to the particular printer a main body command to cause the particular printer to perform a process based on the obtained main body information.

2. The non-transitory computer-readable storage medium according to claim 1,
wherein the obtained main body information includes capability information representing capabilities of the particular printer, and
wherein the support program is further configured to, when executed by the computer, cause the information processing device to:
specify a process executable by the particular printer based on the capability information included in the obtained main body information; and
send to the particular printer the main body command to cause the particular printer to perform the specified process.

3. The non-transitory computer-readable storage medium according to claim 1,
wherein the support program is further configured to, when executed by the computer, cause the information processing device to:
after obtaining the main body information, perform an output instruction reception process to receive an output instruction to output the main body command; and
send the main body command to the particular printer in response to receiving the output instruction in the output instruction reception process.

4. The non-transitory computer-readable storage medium according to claim 1,
wherein the support program is further configured to, when executed by the computer, cause the information processing device to:
when there are a plurality of processes identified as executable by the particular printer based on the obtained main body information, accept selection of a process to be executed by the particular printer from among the plurality of processes; and
send to the particular printer the main body command to cause the particular printer to perform the selected process.

5. The non-transitory computer-readable storage medium according to claim 1,
wherein the support program is further configured to, when executed by the computer, cause the information processing device to:
in response to receiving the specific processing request from the general-purpose print program when the operating system has received the activation instruction with the particular printer selected, display at least part of the obtained main body information.

6. The non-transitory computer-readable storage medium according to claim 1,
wherein the obtained main body information includes:
first main body information that is displayed on a display of the particular printer; and
second main body information that is not displayed on the display of the particular printer, and
wherein the support program is further configured to, when executed by the computer, cause the information processing device to:
display, in said displaying at least part of the obtained main body information, at least the second main body information included in the obtained main body information.

7. The non-transitory computer-readable storage medium according to claim 1,
wherein the support program is further configured to, when executed by the computer, cause the information processing device to:
send, as the main body command, a setting value print command that instructs the particular printer to print a setting value set for the particular printer to the particular printer, thereby causing the particular printer to print the setting value in response to receiving the setting value print command.

8. The non-transitory computer-readable storage medium according to claim 1,
wherein the obtained main body information includes information on a setting value set for the particular printer, and
wherein the support program is further configured to, when executed by the computer, cause the information processing device to:
after obtaining the main body information, display the information on the setting value set for the particular printer that is included in the obtained main body information, and perform a setting value reception process to receive a change instruction to change the setting value set for the particular printer, and a new setting value; and
in response to receiving the change instruction, send, as the main body command, a change command that instructs the particular printer to change the setting value to the particular printer in association with the new setting value received in the setting value reception process, thereby causing the particular printer to set the new setting value associated with the change command in response to receiving the change command.

9. The non-transitory computer-readable storage medium according to claim 1,
wherein the support program is further configured to, when executed by the computer, cause the information processing device to:
send, as the main body command, a test printing command that instructs the particular printer to perform test printing based on the obtained main body information to the particular printer, thereby causing the particular printer to print a test image including an image used for the test printing in response to receiving the test printing command.

10. The non-transitory computer-readable storage medium according to claim 9,
wherein the support program is further configured to, when executed by the computer, cause the information processing device to:
determine the test image for the test printing based on the obtained main body information; and
send, as the main body command, the test printing command including the determined test image to the particular printer, thereby causing the particular printer to print the test image included in the received test printing command in response to receiving the test printing command.

11. The non-transitory computer-readable storage medium according to claim 10,
wherein the support program is further configured to, when executed by the computer, cause the information processing device to:
determine the test image for the test printing based on the obtained main body information; and
send, as the main body command, the test printing command including a particular edited test image with at least part of the obtained main body information written in the determined test image to the particular printer, thereby causing the particular printer to print the particular edited test image included in the received test printing command in response to receiving the test printing command.

12. The non-transitory computer-readable storage medium according to claim 10,
wherein the support program is further configured to, when executed by the computer, cause the information processing device to:
determine the test image for the test printing based on the obtained main body information; and
send, as the main body command, the test printing command including a specific edited test image with information about the support program written in the determined test image to the particular printer, thereby causing the particular printer to print the specific edited test image included in the received test printing command in response to receiving the test printing command.

13. An information processing device comprising:
a communication interface; and
a controller comprising:
a computer; and
a non-transitory computer-readable storage medium storing a general-purpose print program incorporated in advance in an operating system of the information processing device, and computer-readable instructions realizing a support program that is compatible with a particular printer and supports the general-purpose print program, the support program being configured to, when executed by the computer, cause the controller to:
in response to receiving a particular processing request from the general-purpose print program when a print instruction to cause the particular printer to print a target image has been output from an application program incorporated in the information processing device to the general-purpose print program, obtain image data representing the target image from the general-purpose print program, and send a print command based on the obtained image data to the particular printer via the communication interface; and
in response to receiving a specific processing request from the general-purpose print program when the operating system has received an activation instruction to activate the support program with the particular printer selected, obtain main body information of the particular printer from the particular printer via the communication interface, and send a main body command to cause the particular printer to perform a process based on the obtained main body information, to the particular printer via the communication interface.

14. A method implementable by a computer executing computer-readable instructions on an information processing device, the computer-readable instructions realizing a support program that is compatible with a particular printer and supports a general-purpose print program incorporated in advance in an operating system of the information processing device, the method comprising:
in response to receiving a particular processing request from the general-purpose print program when a print instruction to cause the particular printer to print a target image has been output from an application program incorporated in the information processing device to the general-purpose print program, obtaining, by the support program, image data representing the target image from the general-purpose print program, and sending, by the support program, a print command based on the obtained image data to the particular printer; and
in response to receiving a specific processing request from the general-purpose print program when the operating system has received an activation instruction to activate the support program with the particular printer selected, obtaining, by the support program, main body information of the particular printer from the particular printer, and sending, by the support program, to the particular printer a main body command to cause the particular printer to perform a process based on the obtained main body information.
